(19) United States
(12) Patent Application Publication
(10) Pub. No.: US 2009/0041567 A1
(43) Pub. Date: Feb. 12, 2009

(54) Cargo Lifting Platform

(76) Inventor: John Wells, Mequon, WI (US)

Correspondence Address: BOYLE FREDRICKSON S.C., 840 North Plankinton Avenue, MILWAUKEE, WI, 53203, US

(21) Appl. No.: 12/209,570

(22) Filed: Sep. 12, 2008

Related U.S. Application Data
(63) Continuation-in-part of application No. 11/367,826, filed on Mar. 3, 2006, now abandoned.
(60) Provisional application No. 60/658,821, filed on Mar. 4, 2005.

(51) Int. Cl. B60P 1/44

(52) U.S. Cl. 414/545

(57) ABSTRACT

The present invention is a lifting mechanism designed to be releasably attachable to a support, such as a hitch on the rear of a vehicle. The mechanism includes a housing that is securable to the hitch and encloses an operating mechanism having a pair of openings in which lift arms can be connected to be rotated by the operating mechanism. Each lift arm is movably and releasably connected to a platform which can be raised from a lowered position to a raised position by the operating mechanism and the lift arms in order to enable an item placed on the platform to be elevated from a position adjacent the ground to a position generally level with the cargo space of a vehicle, such as the bed of a pickup truck. The components of the mechanism are detachable from one another in order to easily store the mechanism when not in use.

### CROSS-REFERENCE TO RELATED APPLICATIONS

This application claims priority as a continuation-in-part application from U.S. Non-Provisional patent application Ser. No. 11/367,826, filed on Mar. 3, 2006, which claims priority from U.S. Provisional Patent application Ser. No. 60/658,521, filed on Mar. 4, 2005, the entireties of which are expressly incorporated herein by reference.

### FIELD OF THE INVENTION

The present invention relates to lifting mechanisms, and more specifically to lifting mechanisms adapted to be connected to a support for lifting such items, such as into the rear of a vehicle.

### BACKGROUND OF THE INVENTION

In order to transport a number of different types of goods, vehicles are often utilized. Vehicles which have been designed for specific use in transporting goods include beds or other supporting surfaces which may be open or enclosed, and that are usually disposed adjacent the rear of the vehicle. These beds are elevated over the ground on which the vehicle is traveling such that the goods must be elevated to place the items into the bed prior to transport.

With regard to the size of certain items to be transported in smaller vehicles, such as pickup trucks, it is often times difficult to raise these very heavy and/or bulky items into the beds of the trucks. Thus, other lifting mechanisms must be utilized to elevate the item and place the item in the bed of the truck.

A number of lifting mechanisms have been designed which can be attached directly to the rear of the vehicle, such as to a trailer hitch extending rearwardly from the vehicle. However, these mechanisms are often highly complex, involving many moving parts or hydraulic mechanisms which must be constantly maintained in order for the mechanism to function properly.

Further, the majority of these mechanisms when utilized remain permanently attached to the hitch, as the size of the mechanism does not allow for easy removal and/or storage of the mechanism.

As a result, it is desirable to develop a lifting mechanism which can be attached to the rear of a vehicle that is capable of lifting heavy items into the bed of the vehicle, and that has a simple construction that can also be easily removed or disassembled and stored when not in use.

### SUMMARY OF THE INVENTION

According to a primary aspect of the present invention, a lifting mechanism is provided which is releasably attachable to a support, such as a trailer hitch extending rearwardly from a vehicle, e.g., a pickup truck. The mechanism includes an operating mechanism including rotatable members disposed within a housing for the mechanism that is releasably secured to the support. The rotatable members are rotated within the housing using any number of suitable motive systems positioned at least partially within the housing and engaged with the rotatable members. Further, a pair of elongated arms is releasably secured to the rotatable members, such that the arms can rotate in conjunction with the rotatable members. In one mode of operation, the particular motive system used rotates the rotatable members and the arms in opposite directions in order to vertically move or raise the ends of the arms spaced from the housing. Theses end of the arms can releasably support a platform disposed on the ends of each arm that is raised along with the ends of the arms when the motive system is operated. The size and configuration of the arms allows the arms to vertically move the platform or other item secured to one or both of the arms from a lowered position spaced slightly above or on the ground to any of a number of elevated positions, such as a raised position approximately level with the bed of the vehicle.

According to another aspect of the present invention, the arms and the platform can be easily detached from the trailer hitch and from one another to allow the mechanism to be easily reconfigured for additional uses, or disassembled and stored when not in use. Further, the entire operating mechanism can be disconnected from the support to enable the entire mechanism to be removed from the support and stored when not in use, for example to allow another structure to be secured to the support, e.g., the trailer hitch on the vehicle.

According to still another aspect of the present invention, the housing includes stabilizing members that are engageable with the support, e.g., a frame for the vehicle. The stabilizing members are adjustably mounted to the housing such that the members can be moved once the housing is secured to the support to securely engage the support, regardless of the particular shape of the support.

Numerous other aspects, features and advantages of the present invention will be made apparent from the following detailed description taken together with the drawing figures.

### BRIEF DESCRIPTION OF THE DRAWINGS

The drawings illustrate the best most currently contemplated of practicing the present invention.

In the drawings:

FIG. 1 is a front plan view of a first embodiment of the lifting mechanism of the present invention secured to the rear of a vehicle;

FIG. 2 is an exploded, isometric view of the lifting mechanism of FIG. 1;

FIG. 3 is a front plan view of the housing of the lifting mechanism of FIG. 1;

FIG. 4 is a side plan view of a second embodiment of the lifting mechanism of the present invention including support arms;

FIG. 5 is a front plan view of the lifting mechanism of FIG. 4;

FIG. 6 is a side plan view of a third embodiment of the lifting mechanism of the present invention including reconfigurable lifting arms;

FIG. 7 is a front plan view of the lifting mechanism of FIG. 6 in a load-retaining configuration;

FIG. 8 is a side plan view of a fourth embodiment of the lifting mechanism of the present invention including a winch attachment;

FIG. 9 is a front plan view of the lifting mechanism of FIG. 8;

FIG. 10 is a side plan view of a fifth embodiment of the lifting mechanism of the present invention including a secondary support housing;

FIG. 11 is a side plan view of a sixth embodiment of the lifting mechanism of the present invention including a secondary, movable support arm;

FIG. 12 is an isometric view of a pivotable housing for the lifting mechanism of FIG. 1;

FIG. 13 is a side plan view of the pivotable housing of FIG. 12;

FIG. 14 is a cross-sectional view of a first embodiment of an operating mechanism disposed within the housing of FIG. 12;

FIG. 15 is a cross-sectional view of a second embodiment of an operating mechanism disposed within the housing of FIG. 12;

FIG. 16 is a cross-sectional view of a third embodiment of an operating mechanism disposed within the housing of FIG. 12;

FIG. 17 is a side plan view of the operating mechanism of FIG. 16; and

FIG. 18 is a perspective view of the housing for the mechanism including a pair of stabilizing means.

### DETAILED DESCRIPTION OF THE INVENTION

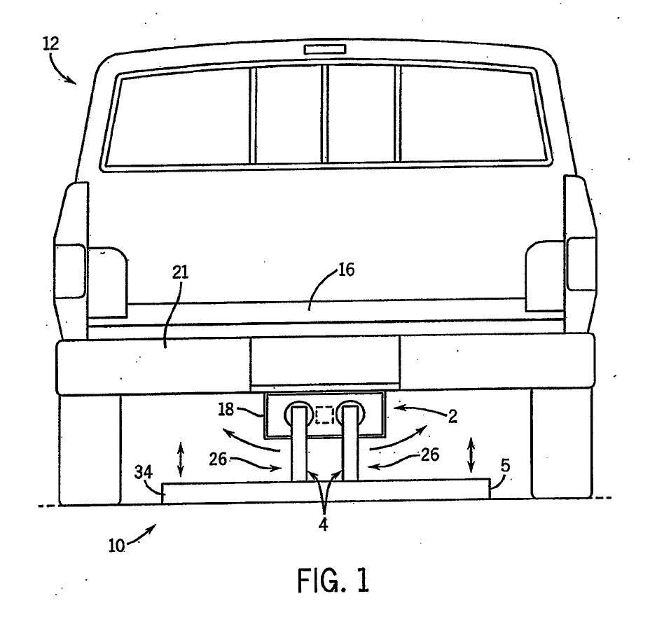

With reference now to the drawing figures in which like reference numerals designate like parts throughout the disclosure, a lifting mechanism constructed according to the present invention is indicated generally at 10 in FIG. 1 and is shown attached to the rear of a vehicle 12. The vehicle 12 includes a hitch 14 positioned adjacent the rear of the vehicle 12, and a cargo bed 16 disposed directly above the hitch 14.

The mechanism 10, as best shown in FIGS. 1-3, includes an operating mechanism 18 including a housing 20 formed of a rigid material, such as a metal or hard plastic, that is releasably securable to the hitch 14 in a suitable manner. The operating mechanism 18 in one embodiment is operably connectable to the electrical or mechanical systems (not shown) for the vehicle 12 in any suitable and well-known manner to operate the mechanism 18. In this embodiment, the mechanism 18 can be automatically actuated, but it is also contemplated that the mechanism 18 can be manually operated, such as by a hand crank (not shown), where the mechanism 18 is not connected to the vehicle 12 for the purposes of supplying power to the mechanism 18.

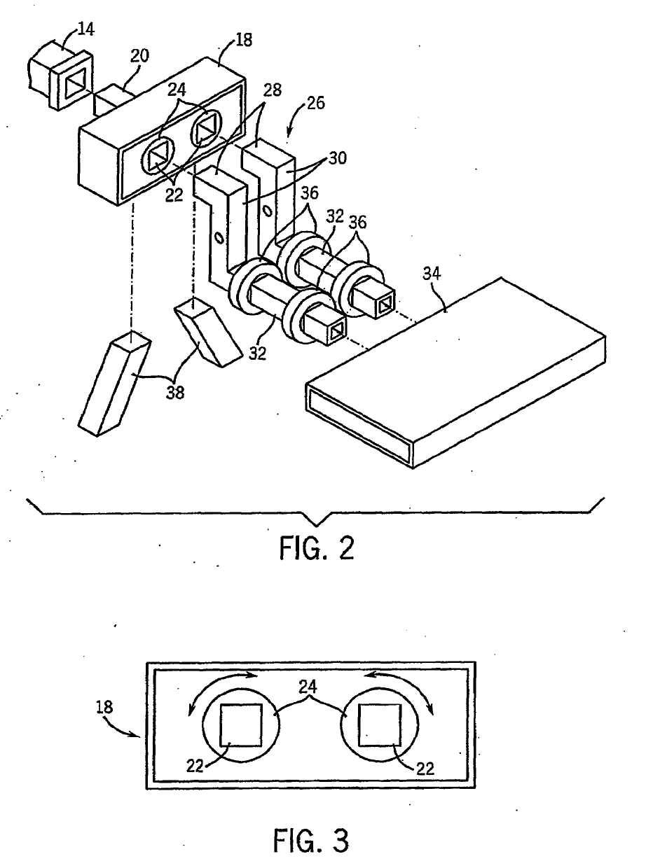

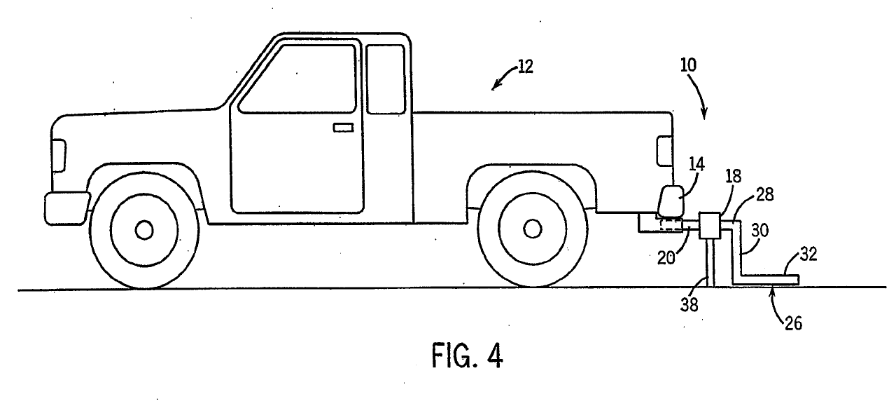

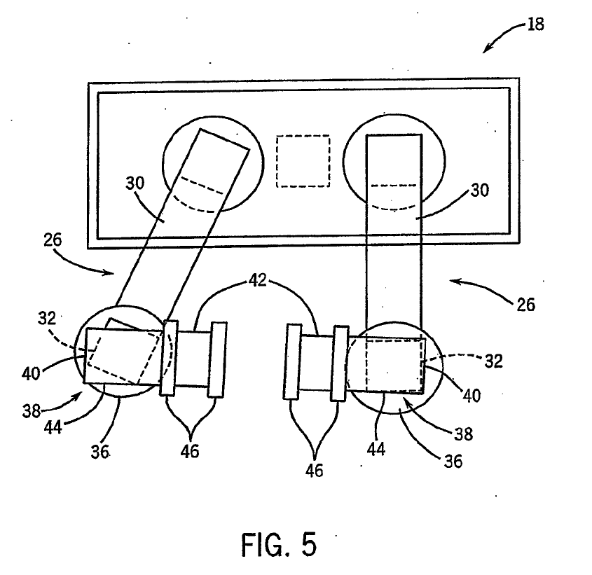

As best shown in the FIG. 2, the housing 20 of the operating mechanism 18 includes a rearward extension 22 that is releasably insertable and securable to the hitch 14 in a known manner. The extension 22 can be formed of a rigid material integrally with the housing 20, or can be a separable part, that is attached to the housing 20 when the mechanism 10 is to be utilized. Additionally, the housing 20 can include a second extension (not shown) that is oriented ninety (90) degrees with respect to the extension 22, such that the housing 20 can be secured to the hitch 14 in a configuration oriented ninety degrees with respect to the vehicle 12. However, it is also envisioned that the housing 20 could be integrally formed within a rear bumper 200 of the vehicle 12. To assist the extension 22 in supporting the housing 20 above the ground, one or more stabilizers 23 can be connected to the underside of the housing 20. The stabilizers 23 extend from the housing 20 downwardly into engagement with the ground to provide additional support for the housing 20. The stabilizers 23 can be formed of a generally rigid material, such as a metal or hard plastic, and can be made to be separable from the housing 20. Alternatively, the stabilizers 23 can be pivotally connected to the underside of the housing 20, such that the stabilizers 23 can simply be pivoted downwardly from the housing 20 when needed, such as when lifting an unusually heavy item. Also, the stabilizer 23 can take the form of a jack or other suitably adjustable support member.

Opposite the extension 22, the housing 20 also includes a pair of openings 24 that are aligned with a pair of rotatable members 26 disposed within the housing 20. The rotatable members 26 each include a central aperture 28 within which is releasably secured a pair of lift arms 30. The lift arms 30, in one embodiment, are formed of tubes, preferably hollow, of a rigid material, such as a metal or hard plastic, having a horizontal securing section 32, a central, vertical section 34, and a horizontal support section 36. The securing section 32 has a shape that corresponds to the shape of each of the apertures 28 formed within the rotatable members 26, which in the preferred embodiment is preferably square in cross-section to enable the rotatable members 26 to easily engage and rotate the lift arms 30 in conjunction with the rotation of the rotatable members 26, such that the arms 30 can be rotated in either direction. However, the configuration of the securing section 32 of each lift arm 30 may be other than as shown in the drawing figures, such that the securing section 32 may have any desired shape suitable for engagement within the aperture 28.

In the embodiment illustrated in FIGS. 1 and 2, each of the lift arms 30 includes a central, vertical section 34 secured at one end to the securing section 32. The central section 34 can be formed to be integral with or separable from the securing section 32, depending upon the desired configuration for the lift arms 30. The preferred configuration is for the central section 34 of each arm to extend perpendicularly from the associated securing section 32. However, depending on the intended ultimate use for the arms 30 and mechanism 10, the central sections 34 of the arms 30 can be formed with other alternative configurations, such as with the central sections 34 of one or both arms 30 extending outwardly away from the securing sections 32 at a desired angle to, for example, increase the overall strength of the arms 30. Additionally, each central section 34 can be formed from two or more separable parts 38 and 40, with part 38 connected, preferably in a permanent manner, to securing section 32, and part 40 connected, preferably in a permanent manner, to support section 36. The parts 38 and 40 are releasably connected to one another in any suitable manner, but are preferably connected by openings 42 formed in the ends of each part 38 and 40 that are alignable with one another to receive a locking pin 44 to secure the parts 38 and 40 to one another, as shown in FIG. 2. The use of the separable parts 38 and 40 enables the arms 30 to be disassembled into easily storable pieces, while also providing and easy-to-assemble construction for the arms 30. Additionally, the use of the separable parts 38 and 40, allows for the use of extensions (not shown) that can be positioned between the respective parts 38 and 40 to increase the overall length of the central section 34 for uses with items or various sizes, and vehicles 12 of varying heights.

Opposite the securing sections 32, each arm 30 also has a support section 36. As stated previously, the support section 36 is connected to at least a part 40 of the central section 34 to form the arm 30, and therefore is preferably formed of a rigid material similar to the material forming the central section 34, and the securing section 32. The support section 36 extends generally perpendicularly from the central section 34, although the position of the support section 36 can be varied with respect to the central section 34 depending upon the particular use for the mechanism 10. For example, the support sections 36 can be formed similarly to the central section 34, with separable parts (not shown) that can be secured to one another and to extensions (not shown) to vary the length of each support section 36 and to increase the ease of storage of the sections 36. Each support section 36 includes a suitable means for engaging and moving in conjunction with a platform 46 that is connected to at least one of the support sections 36 of the lift arms 26. The platform 46 can have any suitable configuration, but is preferably rectangular in shape and is formed of a generally rigid material, such as a plastic or metal. It is also contemplated that the platform 46 made be formed by the tailgate (not shown) of the vehicle 12 such that a separate element is not required. The platform 46 may also be formed to have other features, such as a ramp (not shown) used to enable the item to be lifted to be positioned more easily on the platform 46 either prior to, or after lifting by the mechanism 10.

To hold the platform 46 on the support sections 36 of the arms 30 during operation of the mechanism 10, in a preferred embodiment, the support sections 36 are engaged within brackets 48 disposed on the underside of the platform 46. The brackets 48 loosely hold the support sections 36 therein, such that the support sections 36 can simultaneously slide and rotate with respect to the brackets 48 and the platform 46. Preferably, two opposed pairs of brackets 48 are positioned on the platform 46, with one support section 36 attached to each pair of brackets 48. The attachment of the support sections 36 to the brackets 48 can be done in any suitable manner, such as by inserting a pin (not shown) through the end of each support section 36 extending through the brackets 48, such that the support section 36 cannot be slid out of and removed from the brackets 48 until the pins are removed. In still a further preferred embodiment, each of the support sections 36 includes a number of sliding members 50, such as roller bearings 52 disposed on or around and spaced along the length of the support sections 36. The sliding members serve to facilitate the rotation and sliding of the support sections 36 along the support 46 by contacting the platform 46 a enabling the support sections 36 to move with respect thereto. In the embodiment where the support sections 36 are inserted into brackets 48 on the platform 46, the brackets 48 are formed with sufficient clearance to enable the sliding members 50 to move through the brackets 48 and be positioned in engagement with the brackets 48 or with the platform 46 between the brackets 48. Additionally, in those embodiments where the platform 46 is secured to the support section 36 by means other than brackets 48, the sliding members 50 can simply engage the underside of the platform 46 directly.

To provide additional support to the platform 46 as it is raised and lowered using the mechanism 10, the support sections 36 can include a pair of roller braces 54 pivotally secured to the support sections 36 opposite the central sections 34. The roller braces 54 each include a first component 56 affixed to one of the support sections 36, and a second component 58 connected to the first component 56 by a hinge 60. The second component 58 also includes one or more one-way rollers 62 generally opposite the hinge 60 that allow the second component 58 to engage and roll along the ground when the mechanism 10 is in operation. As the lift arms 30 rotate and move upwardly, the rollers 62 move along the ground and provide support to the platform 46 and support sections 36, as the rollers 62 cannot rotate in the opposite direction. Further, when the platform 46 is in the raised position, the roller braces 54 extend generally vertically downwardly from the ends of the support sections 36 under the platform 46 to engage the ground and provide additional support to the platform 46 opposite the lift arms 30.

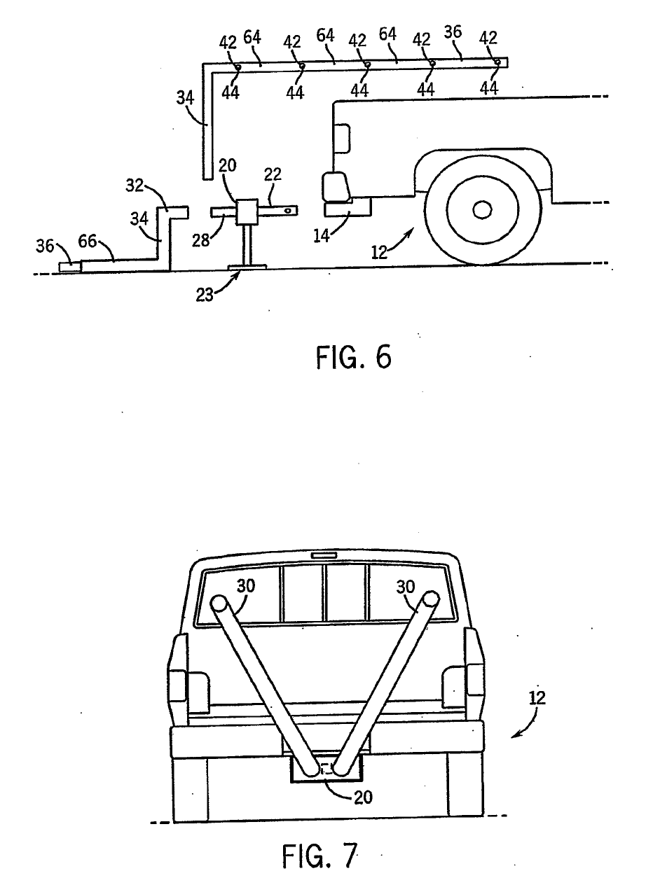

In a third embodiment for the mechanism 10, best shown in FIGS. 6 and 7, the configuration of the lift arms 30 can be varied to include a number of extensions 64 in the central section 34 and the support section 36 of each lift arm 30. In this embodiment, when the item(s) are loaded into the vehicle 12, the lift arms 30 can be rotated by the mechanism 18 to position the support sections 36 over the bed of the vehicle 12, thereby assisting in securing the items within the bed of the vehicle 12. The support sections 36 can also have a padding material 66 positioned around each supporting section 36 to attempt to prevent any damage from being done to the items as a result of contact with the support sections 36. Also, with the extensions 64 in the central section 34, the lift arms 30 can be rotated downwardly into engagement with the ground in order to lift the rear end of the vehicle 12 off of the ground, allowing the vehicle 12 to be extricated from muddy ground or the like, or to facilitate tire changes to the vehicle 12.

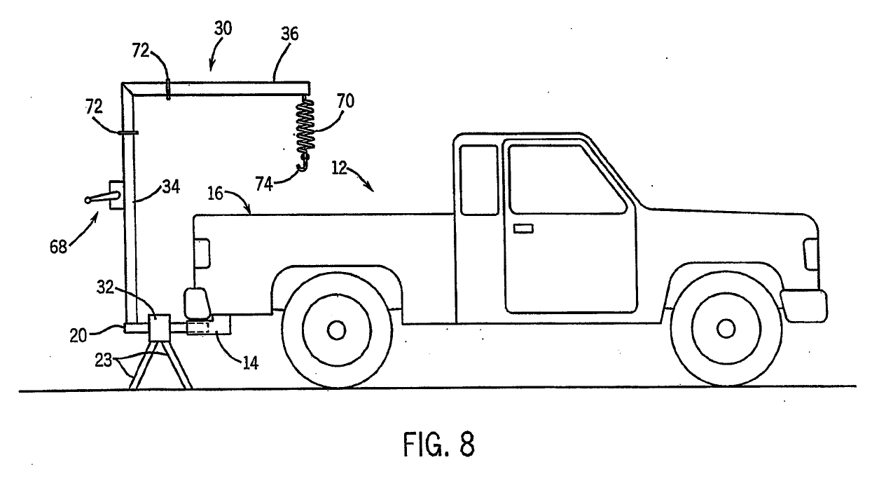

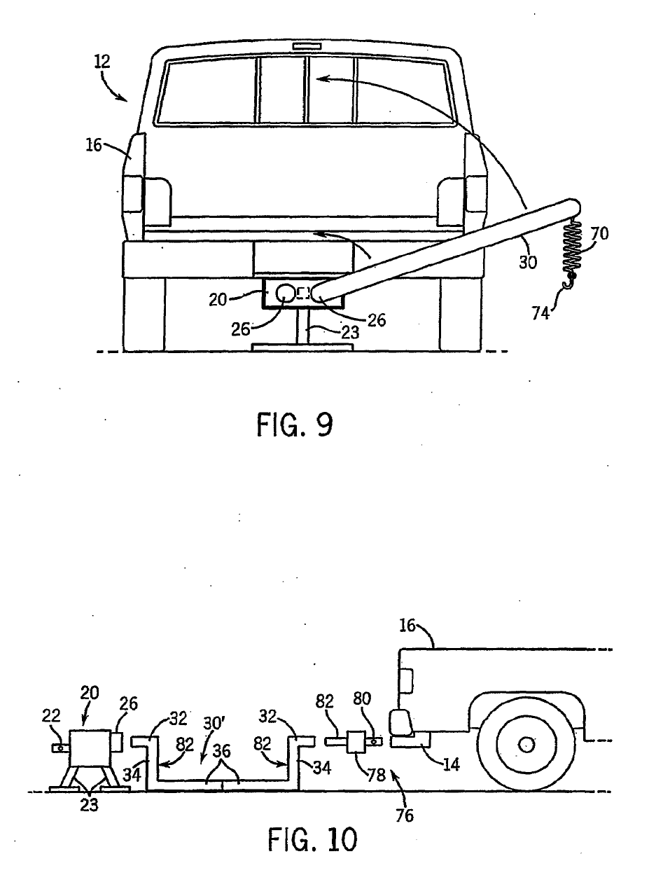

Referring now to FIGS. 8 and 9, a third embodiment of the lifting mechanism 10 is illustrated in which only one lift arm 30 is attached to the housing 20. The lift arm 30 is reconfigured similarly to the arms 30 in the previous embodiment, with extensions 64 added to each of the central section 34 and the support section 36 of the arm 30, such that the central section 34 has a height greater than that of the bed of the vehicle 12. The arm 30 also includes a winch 68 or other suitable manual lifting member secured to the central section 34. A cable 70 or other suitable elongate member is affixed at one end to the winch 68, and extends along the central section 34 from the winch 68, and along the length of the support section 36. The cable 70 is retained on each of the central section 34 and support section 36 by suitable members 72, such as pulleys, clasps or brackets, that keep the cable 70 in alignment with the central section 34 and the support section 36, but that also allow the cable 70 to move with respect to each section 34 and 36. Opposite the winch 68, the cable 70 is attached to a suitable engagement member 74, such as hook or bale spear, among others, to enable the cable 70 to be releasably secured to an item to be moved into the vehicle 12. Once the item is secured to the cable 70 by the engagement member 74, the operating mechanism 18 is activated to rotate the lift arm 30 from a position to one side of the vehicle 12, to a position where the support section 36 is positioned over the vehicle 12. In this position, the winch 68 can be utilized to lower the item held on the engagement member 74 into the bed of the vehicle 12. Items can also be removed from the vehicle 12 by operating the mechanism 10 oppositely to the manner just described.

Looking now at FIG. 10, a fourth embodiment of the lifting mechanism 10 is illustrated in which the mechanism 10 can be used to lift heavy or oversize items into a vehicle 12. The mechanism 10 includes a support box 76 that is formed similarly to the operating mechanism 18, and includes a housing 78, a hitch attachment portion 80 connected to the housing 78 and engageable with a hitch 14, and a pair of rotatable members 82 disposed in the housing 80. However, the support box 76 does not include any operating mechanism 18, such that the box 76 only serves to support one end of the lift arms 30′. Also, the lift arms 30′ are formed of two pairs of arms 82 shaped similarly to the arms 30 utilized in the previous embodiments, with the support sections of the arms 82 connected to one another to form the arms 30′. Each of the arms 30′ can optionally be adjustable in length and is connected at one end to the support box 76, and at the opposite end to the operating mechanism 18. In this embodiment the operating mechanism 18 is spaced from the vehicle 12 and supported by the stabilizers 23. When the operating mechanism 18 is activated, the arms 30′ are caused to rotate in opposite directions, thereby elevating the item positioned on the support sections 36 of each arm 30′, such as on a platform (not shown) connected between the support sections 36. In this configuration, the spacing of the operating mechanism 18 from the vehicle 12 provides added stability to the mechanism 10 in order to lift a heavy and/or oversize item. In this embodiment, the positions of the mechanism 18 and the support box 76 can also be reversed, such that the mechanism 18 is affixed to the vehicle 12 while the support box 76 is spaced therefrom.

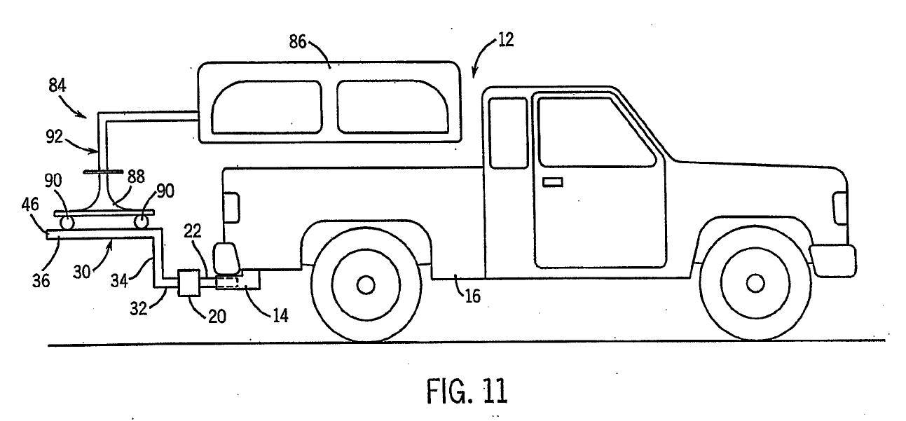

Referring now to FIG. 11, a fifth embodiment of the lifting mechanism 10 of the present invention is illustrated in which the platform 46 supports a truck bed cap-supporting member 84 thereon. The member 84 is releasably securable to a truck bed cap 86, and includes a base 88 including a number of wheels or roller 90, and an upper section 92 that can be rotated or swiveled with respect to the base 86. Thus, to place the cap 86 over the bed 16 of the truck 12, initially the cap 86 is secured to the upper section 92 in any suitable manner. The cap 86 is then lifted by activating the operating mechanism 18 to raise the arms 30 and platform 46, thereby raising the cap-supporting member 84 and the cap 86. Once the cap 86 is disposed above the level of the bed 16 of the vehicle 12, the upper portion 92 is rotated with respect to the base 88, and the base 88 is rolled along the platform 46 towards the vehicle 12. When the cap 86 is directly over the bed 16, the operating mechanism 18 is operated to lower the cap 86 onto the bed 16. The cap 86 can also be removed from the bed 16 by performing the previous operation in the reverse manner.

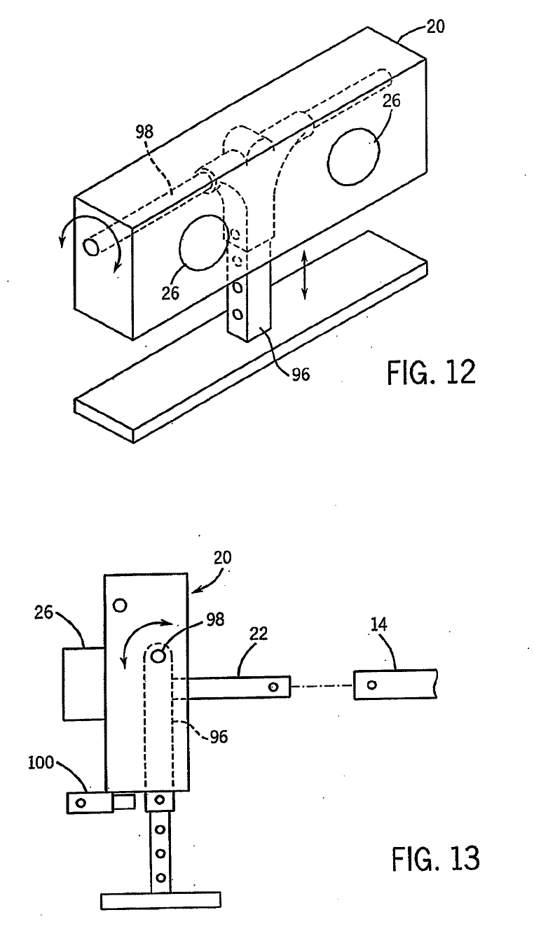

Looking now at FIGS. 12-13, a sixth embodiment of the lifting mechanism 10 of the present invention is illustrated in which the housing 20 is supported above the ground in part by a vertically-adjustable jack 96 secured within the housing 20 at one end to a support shaft 98, and extending outwardly from the housing 20 to selectively engage the ground at the opposite end. The housing 20 also includes a horizontally adjustable jack 100 disposed on the housing 20 in alignment with the jack 96. When the jack 96 is extended to the desired position to support the housing 20 above the ground, the jack 100 can be operated to press against the jack 96 and pivot the housing 20 with respect to the jack 96 along a horizontal axis defined by the shaft 98. By pivoting the housing 20, the angle of the arms 30 can be altered as desired for a particular use of the mechanism 10. Additionally, the housing 20 can also be secured to the jack 96 such that the housing 20 is pivotable with respect to the jack 96 along a vertical axis defined by the jack 96. In pivoting the housing 20 in this manner, the arms 30 can be positioned to function as a take-up reel or winch at the rear of the vehicle 12. When functioning as a winch, a drum (not shown) can be secured to one of the rotatable members 26 and rotated therewith to function as the take-up reel for the winch.

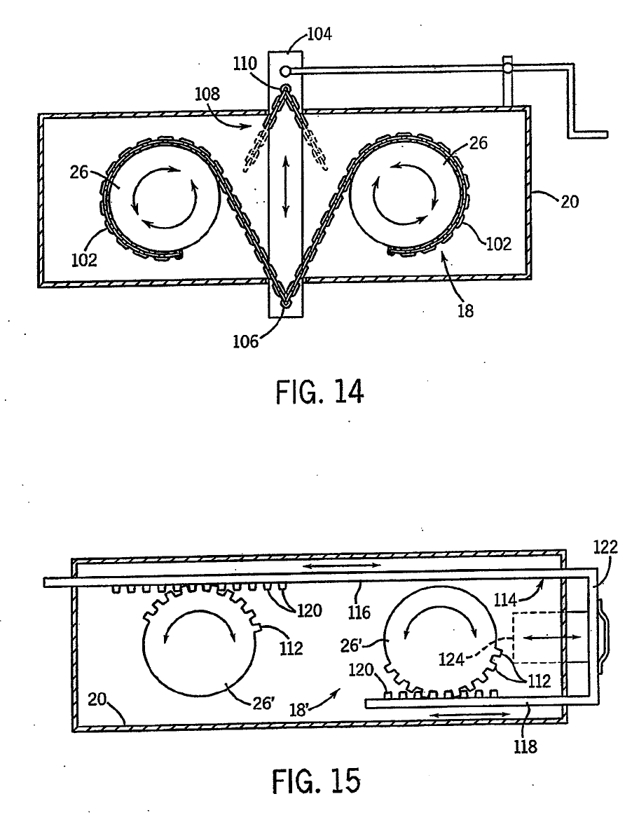

Referring now to FIG. 14, a first embodiment of the operating mechanism 18 disposed within the housing 20 is illustrated. In this embodiment, the rotatable members 26 are each connected to one end of one of a pair of drive chains 102. The drive chain 102 secured to each rotatable member 26 can take any suitable form, such as a bicycle chain, and is operably connected to the rotatable member 26, such as by welding. Opposite the rotatable member 26, each drive chain 102 is affixed to a drive member 104 movably positioned within the housing 20. The drive member 104 can take any suitable form, such as a screw or hydraulic jack, and includes an opening 106 at a lower end to which the drive chains 102 are attached. As the drive member 104 is operated, i.e., is moved downwardly with respect to the housing 20, the drive chains 102 are simultaneously pulled downwardly. This movement of the drive chains 102 causes the chains 102 to pull the rotatable members 26 in opposite directions due to the attachment of the chains 102 to each rotatable member 26. The rotation of the rotatable members 26 consequently causes the arms 30 secured to each rotatable member 26 to rotate in the same direction, thereby elevating the arms 30 between the lowered and raised positions. Further, the mechanism 18 includes one or more return chains 108 secured between the rotatable members 26 and an aperture 110 in the drive member 104, but in the opposite orientation from the drive chains 102. As a result, when the drive member 104 is moved upwardly with respect to the housing 20, the return chains 108 unwind from the rotatable members 26, rotating the rotatable members 26 in a direction to lower the arms connected thereto, and to rewind the drive chains 104 on the rotatable members 26. Thus, when the drive member 104 is moved, the return chains 108 are wound or unwound from the rotatable members 26 oppositely to the drive chains 104, such that the rotatable members 26 are under constant tension in both rotational directions during operation of the lifting mechanism 10 in either direction.

Looking now at FIG. 15, a second embodiment of the operating mechanism 18′ is illustrated. In this embodiment, the operating mechanism 18′ includes rotatable members 26′ having a number of teeth 112 formed around either a specified portion, or the entirety of the circumference of the rotatable members 26′. A sliding pinion 114 is positioned within the housing 20 and includes an upper member 116 and a lower member 118. The upper member 116 includes a number of teeth 120 thereon that are engageable with the teeth 112 on the rotatable member 26′ opposite the pinion 114, while the lower member 118 includes teeth 120 engageable with the teeth 112 on the rotatable member 26′ adjacent the pinion 114. The upper member 116 and the lower member 118 are joined by a connector 122, to which operably connected a jack 124, or other suitable motive member, such as an hydraulic cylinder, or the like. When the jack 124 is operated, the pinion 114 is moved towards or away from the housing 20. The movement of the pinion 114 causes the teeth 120 on the upper members 116 and lower member 118 to engage the teeth 112 on the respective rotatable members 26′ to rotate the rotatable members 26′ in opposite directions to raise or lower the arms 30 connected to the rotatable members 26′.

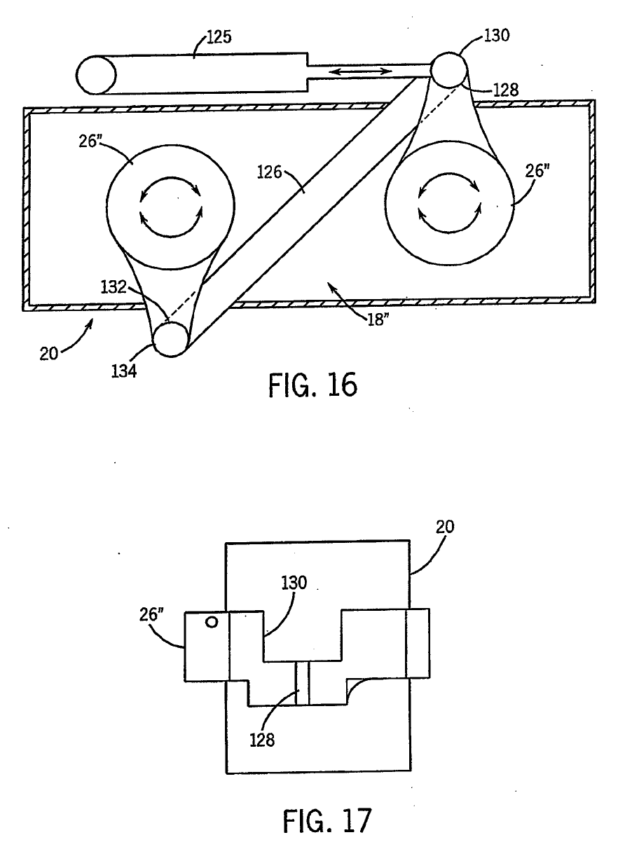

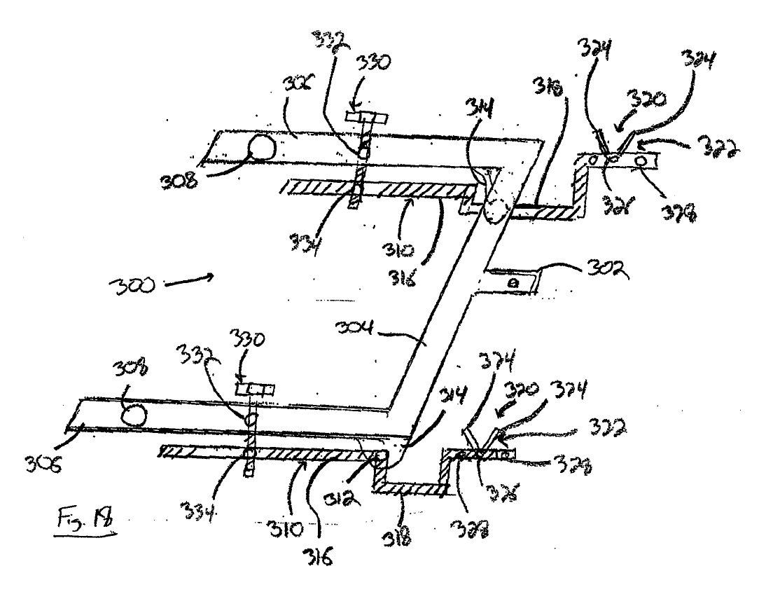

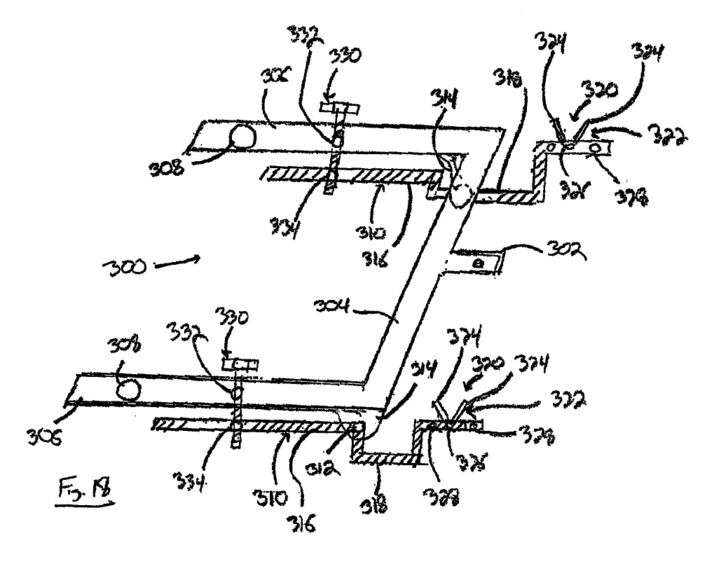

Referring now to FIGS. 16 and 17, a third embodiment of the operating mechanism 18″ is illustrated. The operating mechanism 18″ includes a drive member 125, such as a screw or hydraulic jack, that is operably connected to one end of a link 126. The link 126 is connected at the same end to a slot 128 in an offset 130 formed on one of the rotatable members 26″, and at the opposite end to a similar slot 132 in an offset 134 formed in the opposite rotatable member 26″. When the drive member 125 is operated, the end of the link 126 secured to the drive member 125 is moved towards or away from the drive member 125. This causes the link 126 to move the offset 130, and corresponding rotatable member 26″, towards or away from the drive member in the same direction as the link 126. Due to the attachment of the link 126 to the offset 134 on the opposite rotatable member 26″, this offset 134 and rotatable member 26″ are rotated oppositely of the link 126 when the link 126 is moved towards or away from the drive member 124, thus causing the arms 30 connected to the rotatable members 26″ to be rotated in opposite directions between the raised and lowered positions.

Referring now to FIG. 18, the housing 20 for the mechanism 18 is illustrated as having a frame 300 to which the motive mechanism (not shown) and a suitable covering member (not shown) can be attached. The frame 300, which is preferably formed of a rigid material, such as a metal, and preferably a tubular metal for increased strength, includes an attachment portion 302 extending outwardly from a main frame portion 304 that is used to attach the frame 300 to a support. In a preferred embodiment, the attachment portion 302 is formed as a hitch attachment portion for releasable connection to a hitch (not shown) disposed on a vehicle (not shown). At opposite ends of the main frame portion 304 there are located a pair of attachment members 306 used to affix the motive mechanism to the frame 300. In a preferred embodiment, the attachment members 306 include notches, slots or bores 308, or any other suitable securing mechanism, on each attachment member 306 that are utilized to secure the motive mechanism to the frame 300. The motive mechanism can be secured to the attachment members 306 of the frame 300 by suitable pins or shafts (not shown) that extend outwardly from the motive mechanism into the bores 308. In this manner, the motive mechanism can be easily, and optionally pivotally, attached to the frame 300.

The frame 300 also includes a pair of adjustable securing members 310 disposed on the frame 300, which can optionally be adjustable in length. The adjustable securing members 310 are formed of a generally rigid material, such as a metal, and include a pivot pin 312 secured thereto. The pin 312 is affixed at one or both ends to one or a pair of flanges 314 extending outwardly from the frame 300, through other suitable pivoting connections can also be utilized. The pins 312 in each member 310 are preferably disposed approximate to a central portion 316 of the members 310 to provide sufficient clearance between the frame 300 and the members 310 when the members 310 are pivoted with respect to the frame 300. In addition, in a particularly preferred embodiment, the central portion 316 of each member 310 includes a recessed section 318 that provides added clearance between the frame 300 and the adjustable securing members 310 to provide an even greater range of motion for the members 310.

At the end of each adjustable securing member 310 located nearer the hitch attachment portion 302, the members 310 each include an engagement member 320. The engagement member 320 is adapted to engage a part of the support (not shown) to which the frame 300 is attached, in order to stabilize the frame 300 with regard to the support when the mechanism 18 is in use. Depending upon the form of the support to which the frame 300 is connected, the engagement members 320 can be selected to conform specifically to the shape of the support, or can be selected to have an adaptable configuration that will change shape to accommodate as closely and securely as possible the form of the support. In a preferred embodiment, the engagement members 320 take the form of spring-biased clamps 322 that have a pair of upwardly-extending arms 324 affixed to a spring member 326. The spring member 326 urges the arms 324 toward one another, such that when the arms 324 are deflected away from one another due to contact with the support, such as a vehicle frame (not shown), the arms 324 are urged into engagement with the frame by the bias of the spring member 326. In addition, the engagement members 320 can be movably secured to the members 310 in order for the engagement members 320 to be able to more securely engage the support. In the preferred embodiment using the clamps 322, the clamps 322 are affixed to the adjustable securing members 310 within one of a number of holes 328 formed in the members 310. The positioning of the clamps 322 in one of the holes 328 allows the position of the clamp 322 on the member 310 to be adjusted such that the clamp 322 can be positioned to more effectively engage the support to which the frame 300 is connected.

To control the pivoting motion of the adjustable securing members 310, in a preferred embodiment each member 310 is engaged with one end of an adjustment pin 330. The pins 330 extend through apertures 332 in the attachment members 306 of the frame 300 and are engaged within bores 334 formed in the adjustable securing members 310 spaced from the pivot pins 312 opposite the clamps 322. The pins 330 can be rotated within the apertures 332 to move the members 310 towards or away from the frame 300, thereby causing the clamps 322 to move towards or away from the support. In a particularly preferred embodiment, the pins 330 are threadedly engaged with either the aperture 332 or the bore 334. Thus, when the pin 330 is engaged with the aperture 332 and rotated, the engagement of the pin 330 with the aperture 332 causes the pin 330 to rise or lower with regard to the aperture 332, consequently causing the member 310 to pivot in the corresponding direction as a result of the connection between the pin 330 and the member 310. In the case where the pin 330 is threadedly engaged with the member 310, the rotation of the pin 330 causes the member 310 to move up or down the pin 310 as the pin 330 is rotated. In either manner, the rotation of the pin 330 causes the clamp 322 to move into or out of engagement with the support to hold the frame 300 in secure engagement with the support.

While the previous description has illustrated the best modes contemplated of carrying out the present invention, other alternative embodiments and configurations for the lifting mechanism 10 are also possible. For example the operating mechanism 18 can be formed from rotatable members 26 taking the form, in whole or in part, of gears (not shown) that are engaged by a worm gear (not shown) disposed in the housing 20 and capable of rotating the gear portions of the rotatable members 26 in opposite directions. Additionally, the motive power for the operating mechanism 18, apart from being manually supplied or supplied from the vehicle 12, can come from a separate power source, such as an electrical outlet (not shown) or a generator (not shown). Also, the mechanism 10 can be secured to objects other than a vehicle 12, such as to a trailer towed by the vehicle 12 or separate support, such as a loading dock wall. Further, in the embodiment of FIG. 10, to assist an individual in getting items off of on onto the platform secured to the arm 36, a step attachment (not shown) can be provided that is securable t the platform or to the housing 20 to enable the item to be walked up onto of off of the platform secured between the arms 36.

Various alternatives are contemplated as being within the scope of the following claims, particularly pointing out and distinctly claiming a subject matter regarded as the invention.

I hereby claim:

1. A lifting mechanism comprising:
a) an operating mechanism attachable to a vehicle, the operating mechanism comprising a drive housing attachable directly to the vehicle and a support housing adapted to be spaced from the vehicle and the drive housing;
b) at least one lift arm rotatably connected at opposite ends between the support housing and the drive housing of the operating mechanism; and
c) a lifting implement securable to the at least one lift arm between the support housing and the drive housing.

2. The mechanism of claim 1 further comprising a pair of lift arms releasably and rotatably connected at opposite ends between the support housing and the drive housing of the operating mechanism.

3. The mechanism of claim 2 wherein the pair of lift arms are rotatable in opposite directions by the drive housing of the operating mechanism.

4. The mechanism of claim 2 wherein each of the pair of lift arms comprises:
a) a pair of securing sections secured to the support housing and the drive housing of the operating mechanism;
b) a pair of central sections secured to the securing sections opposite the support housing and the drive housing of the operating mechanism; and
c) a support section secured to the central sections opposite the securing sections.

5. The mechanism of claim 3 wherein each of the central sections comprises:
a) a first part secured to the adjacent securing section; and
b) a second part secured to the support section, wherein the first part is releasably secured to the second part.

6. The mechanism of claim 5 further comprising at least one extension releasably secured between the first part and the second part.

7. The mechanism of claim 5 further comprising at least one extension releasably secured to the second part.

8. The mechanism of claim 1 wherein the support housing includes at least one supporting member secured to the support housing and adapted to support the support housing at the location spaced from the drive housing.

9. The mechanism of claim 8 wherein the at least one supporting member is pivotally attached to the support housing.

10. The mechanism of claim 1 further comprising at least one stabilizing arm secured to the drive housing and engageable with the vehicle separately from the drive housing.

11. The mechanism of claim 10 wherein the at least one stabilizing arm is adjustably secured to the drive housing.

12. The mechanism of claim 11 further comprising an adjustment member connected between the drive housing and the at least one stabilizing arm, the adjustment member operable to adjust the position of the at least one stabilizing arm with respect to the drive housing.

12. The mechanism of claim 11 wherein the at least one stabilizing arm is pivotally secured to the drive housing.

13. The mechanism of claim 10 wherein the at least one stabilizing arm includes at least one engagement clamp adapted to engage the vehicle at a location spaced from the drive housing.

14. The mechanism of claim 1 wherein the drive housing of the-operating mechanism further comprises:
a) at least one engaging member adapted to secure the drive housing to the vehicle;
b) at least one rotatable member disposed at least partially within the drive housing, the at least one rotatable member defining an aperture for receiving one end of the at least one lift arm; and
c) a motive mechanism disposed within the drive housing and operatively connected to the at least one rotatable member and configured to rotate the at least one lift arm.

15. The mechanism of claim 14 further comprising:
a) a pair of rotatable members disposed at least partially within the drive housing, each of the pair of rotatable members defining an aperture therein; and
b) a pair of lift arms secured to the pair of rotatable members, each of the pair of lift arms being rotatable by the motive mechanism in opposite directions.

16. The mechanism of claim 15 wherein each of the pair of rotatable members is operatively connected to a motive mechanism disposed within the drive housing.

17. The mechanism of claim 14 wherein the motive mechanism comprises:
a) a drive member disposed within the drive housing and connected to a power source for the motive mechanism; and
b) at least one connection member secured to the drive member at one end and to the pair of rotatable members at the opposite end.

18. A method for lifting an item into a cargo area of a vehicle, the method comprising the steps of:
a) providing a lifting mechanism including an operating mechanism releasably connectable to the rear of the vehicle, the operating mechanism comprising a drive housing attachable directly to the vehicle and a support housing adapted to be spaced from the vehicle and the drive housing, at least one lift arm connectable at opposite ends between the support housing and the drive housing of the operating mechanism, and a lifting implement releasably connectable to the at least one lift arm;
b) connecting the lifting mechanism to the rear of the vehicle;
c) engaging the item to be lifted with the lifting implement; and
d) activating the operating mechanism to elevate the at least one lift arm, the implement and the item with respect to the vehicle.

19. The method of claim 18 further comprising the step of detaching the lifting mechanism from the vehicle after activating the operating mechanism.

20. The method of claim 19 wherein the step of detaching the lifting mechanism from the vehicle comprises:
a) removing the lifting mechanism from the vehicle; and
b) disassembling the lifting mechanism for storage.

21. The method of claim 20 further comprising the step of reassembling the lifting mechanism for reattachment to the vehicle.

22. A lifting mechanism comprising:
a) an operating mechanism attachable to a support, the operating mechanism comprising a first housing attachable directly to the support and a second housing adapted to be spaced from the support and the first housing;
b) at least one lift arm rotatably connected at opposite ends between the first housing and the second housing of the operating mechanism; and
c) a lifting implement securable to the at least one lift arm between the first housing and the second housing.

23. The lifting mechanism of claim 22 wherein one of the first housing or the second housing includes a motive mechanism.
